(19) United States
(12) Patent Application Publication
(10) Pub. No.: US 2008/0005774 A1
(43) Pub. Date: Jan. 3, 2008

(54) Digital broadcast receiving apparatus and digital broadcast receiving method

(75) Inventors: Koji Okada, Tokyo (JP); Michihiro Fukushima, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/808,985

(22) Filed: Jun. 14, 2007

(30) Foreign Application Priority Data
Jun. 30, 2006 (JP) 2006-182443

(51) Int. Cl. H04N 7/00

(52) U.S. Cl. 725/134

(57) ABSTRACT

According to one embodiment, a digital broadcast receiving apparatus has a receiving device selecting and receiving a broadcast wave of a digital broadcast and a demodulation device demodulating a received broadcast signal to generate a transport stream. The digital broadcast receiving apparatus has an identification information storing device storing packet identification information for identifying a transport packet of each channel included in the transport stream generated by the demodulation device and a control device controlling to output a video or a sound using the packet identification information stored by the identification information storing device, in the event that a channel is switched, when a channel after switching after the switch-over is performed coincides with the channel whose packet identification information is stored by the identification information storing device.

### CROSS-REFERENCE TO RELATED APPLICATIONS

This application is based upon and claims the benefit of priority from Japanese Patent Application No. 2006-182443, filed Jun. 30, 2006, the entire contents of which are incorporated herein by reference.

### BACKGROUND

1. Field

One embodiment of the invention relates to a digital broadcast receiving apparatus and a digital broadcast receiving method for receiving a broadcast wave of a terrestrial digital broadcast, a satellite broadcast or the like and performing a demodulation processing to reproduce a video signal and a sound signal.

2. Description of the Related Art

In recent years, a digital broadcast receiving apparatus is becoming popular which receives a broadcast wave of a satellite digital broadcast such as a terrestrial digital broadcast, a BS (Broadcasting Satellite) broadcast or a 110-degree CS (Communication Satellite) broadcast and reproduces a digitalized video signal and sound signal.

Conventionally, various digital broadcast receiving apparatuses are known, and for example in Japanese Patent Application Publication (KOKAI) No. 2005-354283 (Patent Document 1), there is disclosed a digital broadcast receiving apparatus which reduces a time required until a program of a channel after switching can be viewed in the event that a channel is switched. In this digital broadcast receiving apparatus, any one of a plurality of broadcast receiving devices is set to be in a view reception state or a standby reception state in which a broadcast of a preferred view channel designated by a user is received, so that a video and a sound from the broadcast receiving device which is set to be in the standby reception state are outputted when a broadcast channel desired by the user coincides with the preferred view channel.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a digital broadcast receiving apparatus according to an embodiment of the invention;

FIG. 2 is an exemplary diagram showing an example of a configuration of a PID table in the embodiment;

FIG. 3 is an exemplary flowchart showing operation procedures of a packet ID checking processing performed in the event that a channel switch-over is performed in the digital broadcast receiving apparatus in the embodiment;

FIG. 4 is an exemplary diagram schematically showing a relationship of three TS packets in the embodiment; and

FIG. 5 is an exemplary flowchart showing operation procedures of a packet ID updating processing in the embodiment.

### DETAILED DESCRIPTION

Various embodiments according to the invention will be described hereinafter with reference to the accompanying drawings. In general, according to one embodiment of the invention, a digital broadcast receiving apparatus has a receiving device selecting and receiving a broadcast wave of a digital broadcast and a demodulation device demodulating a received broadcast signal to generate a transport stream. The digital broadcast receiving apparatus has an identification information storing device storing packet identification information for identifying a transport packet of each channel included in the transport stream generated by the demodulation device and a control device controlling to output a video or a sound using the packet identification information stored by the identification information storing device, in the event that a channel is switched, when a channel after switching after the switch-over is performed coincides with the channel whose packet identification information is stored by the identification information storing device.

In a digital broadcast receiving method, there is stored packet identification information for identifying a transport packet of each channel included in a transport stream generated by a demodulation device, and it is controlled such that a video or a sound is outputted using the stored packet identification information, in the event that a channel is switched, when a channel after switching after the switch-over is performed coincides with the channel whose packet identification information is stored.

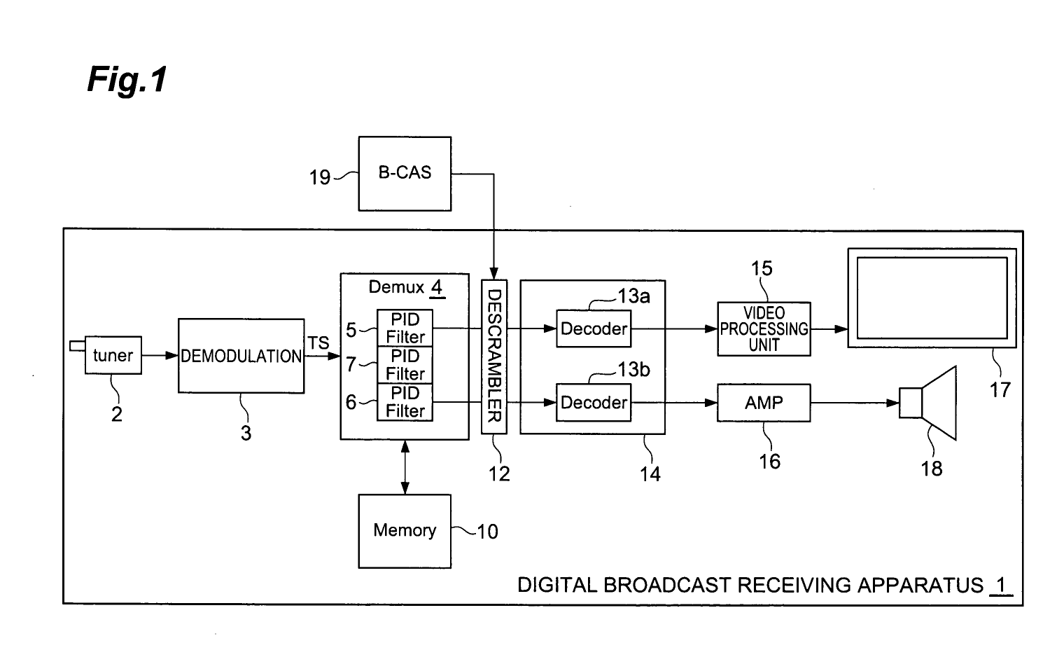

FIG. 1 is a block diagram showing a configuration of a digital broadcast receiving apparatus 1 according to an embodiment of the present invention. As shown in FIG. 1, the digital broadcast receiving apparatus 1 has a tuner 2, a demodulation circuit 3, a demultiplexer 4, a PID memory 10, a descrambler 12, and a decoder 14. Further, the digital broadcast receiving apparatus 1 has a video processing unit 15, a sound processing unit 16, a display device 17, and a speaker 18.

The tuner 2 is supplied with a broadcast wave received by an unshown antenna for a terrestrial digital broadcast (though the antenna is assumed to be the antenna for the terrestrial digital broadcast in the present embodiment, an antenna for a satellite digital broadcast may be used). The tuner 2 performs a receiving processing of selecting and receiving a signal component with a predetermined frequency corresponding to a designated channel from the broadcast wave supplied from the antenna, and outputs the signal component to the demodulation circuit 3.

Incidentally, though the tuner 2 is configured for the terrestrial digital broadcast in the present embodiment, the tuner 2 may be configured for the satellite digital broadcast. Further, the digital broadcast receiving apparatus 1 may have both of the tuner configured for the terrestrial digital broadcast and the tuner configured for the satellite digital broadcast.

The demodulation circuit 3 performs a predetermined demodulation processing for the signal component extracted by the tuner 2 and further performs a processing of fault correction or the like to generate a transport stream TS. The generated transport stream TS is inputted to the demultiplexer 4.

The demultiplexer 4, with reference to packet identification information (referred also to as a packet ID, PID) added to each packet (TS packet) of the transport stream TS, judges kinds of a video, a sound and other data which are included in a payload of each TS packet.

The demultiplexer 4 is provided with PID filters 5, 6, 7 as shown in FIG. 1. It is designed that the packet ID read from the PID memory 10 in the event that the channel is switched is set in the PID filters 5, 6, 7, in correspondence with the kind of the data such as the video, the sound and other data (a program name of a program to be broadcasted, a broadcast time and the like).

Further, the multiplexer 4 has a function as a storage control device which acquires the packet ID from the transport stream TS to make a later-described PID table 20 of the PID memory 10 store the packet ID.

Further, by acquiring a PAT and a PMT which will be described later, the demultiplexer 4 recognizes a packet ID of a video, a sound and the like to be received and outputs the TS packet with the packet ID coinciding with the recognized packet ID to the descrambler 12, with the TS packet being divided into a video signal and a sound signal. Incidentally, since the transport stream TS is coded, a descrambling processing is performed by the descrambler 12.

Here, the PAT (Program Association Table) has a function of designating a packet ID of a TS packet transmitting a PMT which is associated with a broadcast program. The PAT together with the PMT constitutes packet designation information.

The PMT (Program Map Table) has a function of designating a packet ID of a TS packet transmitting respective coded signals (video signal, sound signal and the like) constituting the broadcast program and packet ID of a TS packet transmitting a common information (for example, ECM: Entitlement Control Message; information about the program, a key for descrambling or the like) among related information of a pay broadcast.

The descrambler 12 inputs coded key information necessary for descrambling from a descrambling card 19 and using the coded key information, descrambles the coded TS packet outputted from the demultiplexer 4, and outputs the descrambled TS packet to the decoder 14.

The decoder 14 has a video decoder 13a and a sound decoder 13b. The video decoder 13a performs a decoding processing on the inputted TS packet to generate a digital video signal and outputs the digital video signal to the video processing unit 15. The sound decoder 13b performs the decoding processing on the inputted TS packet to generate a digital sound signal and outputs the digital sound signal to the sound processing unit 16.

The video processing unit 15 performs a processing of converting the digital video signal outputted from the video decoder 13a to an analog video signal and outputs the analog video signal to the display device 17. The sound processing unit 16 not only converts the digital sound signal outputted from the sound decoder 13b to an analog sound signal but also performs a processing such as amplifying and outputs the analog sound signal to the speaker 18. The display device 17, having a liquid crystal display panel or the like, displays a video corresponding to the inputted analog video signal on the liquid crystal display panel or the like. The speaker 18 inputs the analog sound signal and outputs a sound.

The descrambling card 19 is a B-CAS (BS-Conditional Access Systems) card and a card to be used for copyright protection of a program distributed via the digital broadcast or for viewing of the pay broadcast and so on. This B-CAS card is used in a restricted reception system (B-CAS system) provided by BS Conditional Access Systems Co., Ltd., and is used by being inserted to a predetermined card slot provided in the digital broadcast receiving apparatus 1.

In this descrambling card 19 is stored coded key information necessary when descrambling the coded TS packet outputted from the demultiplexer 4. The descrambling card 19 is necessary for a broadcast program whose reception is restricted, and it is a must to insert the descrambling card 19.

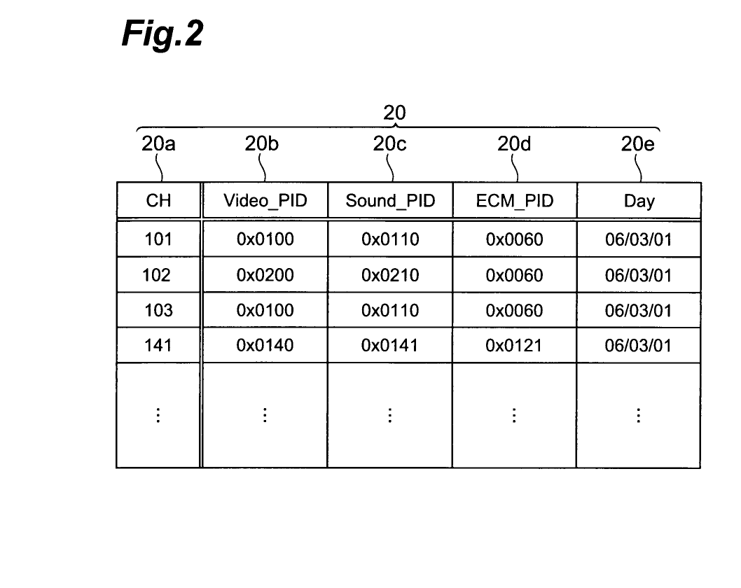

Here, the PID table 20 stored in the PID memory 10 will be described with reference to FIG. 2. FIG. 2 is a diagram showing an example of a configuration of the PID table 20. The PID table 20 is an identification information storing device and has a channel storing unit 20a, a video PID storing unit 20b, a sound PID storing unit 20c, an ECM-PID storing unit 20d and an update date storing unit 20e. It is designed that the packet IDs of the TS packets transmitting the video, the sound, and the ECM respectively as well as a date of acquiring these packet IDs are stored in the PID table 20 channel by channel.

In the channel storing unit 20a is stored a channel code for specifying a channel. In the PID storing unit 20b, the packet ID of the TS packet transmitting the video signal is stored per the channel code stored in the channel storing unit 20a. In the sound PID storing unit 20c, the packet ID of the TS packet transmitting the sound signal is stored per the channel code, and in the ECM-PID storing unit 20d, the packet ID of the TS packet transmitting the ECM is stored per the channel code. In the update date storing unit 20e an update date per the channel code is stored.

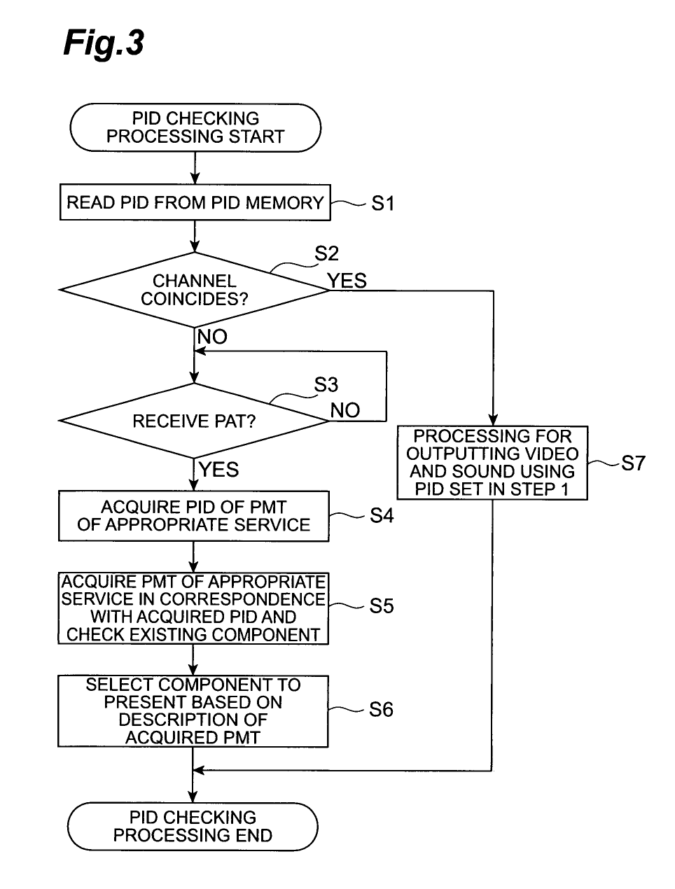

Next, there will be described a content of an operation in the event that the channel is switched in the digital broadcast receiving apparatus 1 having the above configuration, with reference to a flowchart shown in FIG. 3. FIG. 3 is the flowchart showing operation procedures of a PID checking processing performed in the event that the channel is switched in the digital broadcast receiving apparatus 1. This PID checking processing is performed by the demultiplexer 4 in the event that the channel is switched.

When the demultiplexer 4 starts the PID checking processing, the demultiplexer 4 proceeds the processing to a block 1 and performs an operation as a packet identification information setting device, reading each packet ID of each channel from the PID table 20 stored in the PID memory 10 and setting the packet ID in the PID filters 5, 6, 7.

Subsequently, the demultiplexer 4 proceeds the processing to a block 2 and performs an operation as a judging unit. In other words, the demultiplexer 4 judges whether or not a presently receiving channel (a channel after the switch-over is performed, a channel after switching) coincides with the channel (stored channel) whose packet ID is stored in the PID table 20, using each packet ID set in the block 1.

Here, if the channel after switching does not coincide with the stored channel, the demultiplexer 4 proceeds the processing to a block 3. If the channel after switching coincides with the stored channel (when a channel coincidence in which mutual channels coincide with each other is realized), the demultiplexer 4 performs an operation as a control device and proceeds the processing to a block 7. When the demultiplexer 4 proceeds the processing to the block 7, the demultiplexer 4 performs a processing for outputting the video or the sound using the packet ID set in the block 1.

Next, when the demultiplexer 4 proceeds the processing to the block 3, the demultiplexer 4 switches a transport stream as necessary and wait until receiving the TS packet transmitting the PAT. Then on receiving the TS packet transmitting the PAT, the demultiplexer 4 proceeds the processing to a block 4. Here, the demultiplexer 4 acquires a packet ID of a TS packet transmitting a PMT of an appropriate service (in the present embodiment, assumed to be a program of the terrestrial digital broadcast), according to the PAT of the received TS packet.

Subsequently, when the demultiplexer 4 proceeds the processing to a block 5, the demultiplexer 4 acquires the PMT of the appropriate service from the TS packet corresponding to the packet ID acquired in the block 4 and checks components such as the video signal and the sound signal which exist therein. Further, the demultiplexer 4 proceeds the processing to a block 6, and, according to the PMT acquired in the block 5, selects a coded signal of the component to be presented by video displaying of the display device 17 or sound outputting of the speaker 18. By the processings hereinafter, the TS packet with the packet ID designated by the PMT is outputted to the descrambler 12.

By the operations as above, the TS packet for acquiring the required video signal, sound signal or the like is specified and the appropriate TS packet is outputted to the descrambler 12.

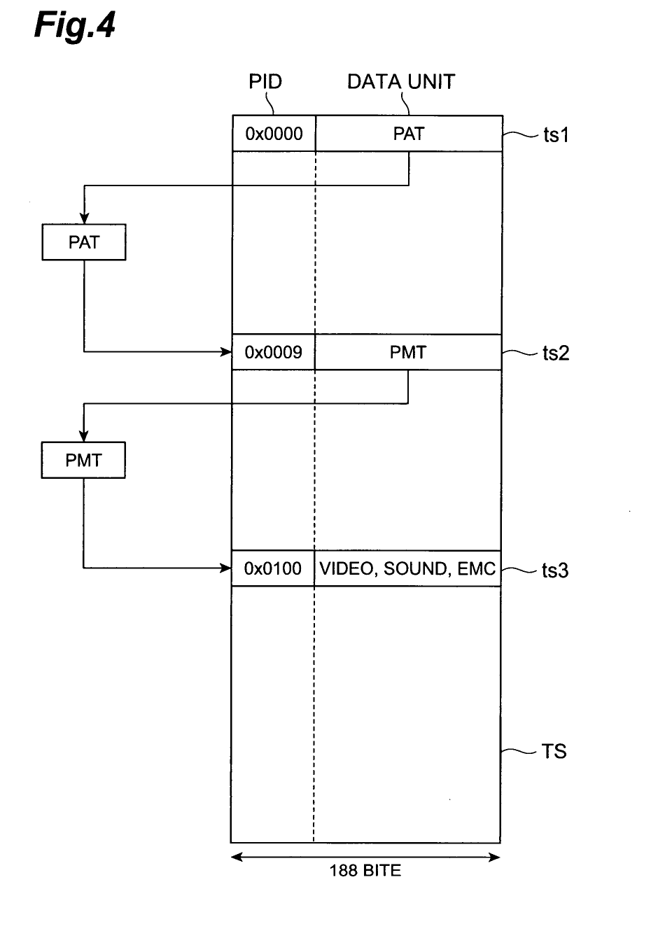

Here, in FIG. 4 is shown a relationship of a TS packet ts1 transmitting the PAT, a TS packet ts2 transmitting the PMT, and a TS packet ts3 transmitting the coded signal (video signal, sound signal, ECM or the like) for providing the appropriate service such as a program of the terrestrial digital broadcast, among the transport streams TS.

The TS packet ts1, whose packet ID is “0x0000”, includes the PAT in a payload. By the PAT included in the TS packet ts1, a packet ID “0x0009” of the TS packet ts2 transmitting the PMT is designated. A payload of the TS packet ts2 includes the PMT. By the PMT included in the TS packet ts2, a packet ID “0x0100” of the TS packet ts3 transmitting the coded signal is designated.

As stated above, it is designed that the PMT is designated by receiving the PAT and by this PMT the TS packet ts3 transmitting each coded signal constituting the broadcast program to be received as well as the common information is designated. Both the PAT and the PMT are retransmitted in a predetermined retransmission cycle (100 ms), and in order that the demultiplexer 4 recognizes the TS packet ts3, it is necessary to wait until receiving the PAT and the PMT which are transmitted in that retransmission cycle and to specify both of them.

However, the digital broadcast receiving apparatus 1 has the above-described configuration and performs the PID checking processing as stated above in the event that the channel is switched, so that the following operation and effect can be obtained.

The digital broadcast receiving apparatus 1 stores the packet ID of the channel required for acquiring the video signal and the sound signal to be received in the PID table 20 of the PID memory 10. Further, the digital broadcast receiving apparatus 1 judges whether or not the receiving channel coincides with the stored channel whose packet ID is stored in the PID table 20 in the PID checking processing performed in the event that the channel is switched.

When the both coincide with each other, since a necessary TS packet can be obtained by using the packet ID (this packet ID is set in the PID filters 5, 6, 7 in the above description) stored in the PID table 20, it is unnecessary to designate the packet ID by the PAT and the PMT and it is also unnecessary to wait until receiving the PAT and the PMT.

In other words, since the digital broadcast receiving apparatus 1 can perform subsequent processings without waiting for the reception of the PAT and the PMT, designation of the packet ID required in the event that the channel is switched is simplified so that the time necessary until the program after the switch-over can be viewed is able to be shortened.

However when the receiving channel does not coincide with the stored channel whose packet ID is stored in the PID table 20, it is necessary to wait for the reception of the PAT and the PMT. Therefore the time required for the switch-over is not shortened.

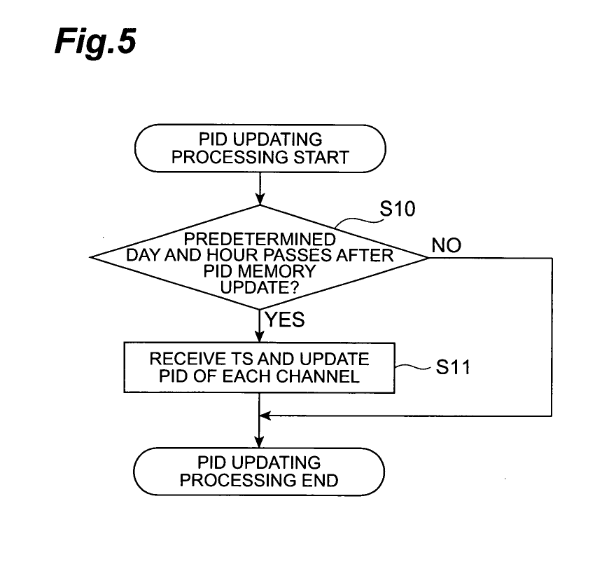

Meanwhile, since the packet ID of each channel is updated when a predetermined day and hour pass, it is desirable that the packet ID stored in the PID table 20 of the PID memory 10 is updated periodically. Thus, the demultiplexer 4 performs a packet ID updating processing in accordance with a flowchart shown in FIG. 5.

When the demultiplexer 4 starts the packet ID updating processing, the demultiplexer 4 proceeds the processing to a block 10 to perform an operation as an elapsed day and hour judging unit. In this case, the demultiplexer 4 judges whether or not the elapsed day and hour since the packet ID is stored in the PID table 20 exceed a predetermined day and hour (about several days) as a threshold value. If the demultiplexer 4 judges that the elapsed day and hour exceed the predetermined day and hour, the demultiplexer 4 proceeds the processing to a block 11, and if not, the demultiplexer 4 terminates the packet ID updating processing without performing the processing of the block 11.

Further, when the demultiplexer 4 proceeds the processing to the block 11, the demultiplexer 4 performs an operation as an update control device, acquiring the packet ID of each channel and making the PID table 20 store the packet ID to update the PID table 20.

By performing the packet ID updating processing, the packet ID stored in the PID table 20 can be constantly kept in a latest state. Therefore, the coincidence of the packet IDs is achieved and designation of the packet ID can be simplified, so that the time required for the switch over can be shortened.

The above explanation is for the embodiment of the present invention and is not to limit the apparatus and method according to the present invention, and various modification examples can be simply implemented. Further, any device or method configured by appropriately combining components, functions, characteristics or method steps in each embodiment is included in the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital broadcast receiving apparatus having a receiving device selecting and receiving a broadcast wave of a digital broadcast and a demodulation device demodulating a broadcast signal received by the receiving device to generate a transport stream, said digital broadcast receiving apparatus comprising:
an identification information storing device storing packet identification information for identifying a transport packet of each channel included in the transport stream generated by the demodulation device; and
a control device controlling to output a video or a sound using the packet identification information stored by said identification information storing device, in the event that a channel is switched, when a channel after switching after the switch-over is performed coincides with the channel whose packet identification information is stored by said identification information storing device.

2. The digital broadcast receiving apparatus according to claim 1, further comprising a storage control device acquiring the packet identification information from the transport stream and making said identification information storing device store the packet identification information.

3. The digital broadcast receiving apparatus according to claim 2, wherein said storage control device makes the packet identification information to be stored, with the packet identification information being divided into a video signal, a sound signal and others.

4. The digital broadcast receiving apparatus according to claim 1, further comprising a judging device judging whether or not the channel after switching coincides with the channel whose packet identification information is stored by said identification information storing device in the event that the channel is switched,
wherein said control device performs control based on a judgment result of said judging device.

5. The digital broadcast receiving apparatus according to claim 2, further comprising:
an elapsed day and hour judging device judging whether or not an elapsed day and hour since said storage control device makes said identification information storing device store the packet identification information exceed a threshold value; and
an updating control device updating said identification information storing device by making the packet identification information to be stored when the elapsed day and hour are judged to exceed the threshold value by said elapsed day and hour judging device.

6. The digital broadcast receiving apparatus according to claim 1, further comprising:
a PID filter in which the packet identification information is set; and
a packet identification information setting device reading the stored packet identification information from said identification information storing device and setting the packet identification information in said PID filter in the event that the channel is switched.

7. A digital broadcast receiving method in a digital broadcast receiving apparatus having a receiving device selecting and receiving a broadcast wave of a digital broadcast and a demodulation device demodulating a broadcast signal received by the receiving device to generate a transport stream, said digital broadcast receiving method comprising:
storing packet identification information for identifying a transport packet of each channel included in the transport stream generated by the demodulation device; and
controlling to output a video or a sound using the stored packet identification information, in the event that a channel is switched, when a channel after switching after the switch-over is performed coincides with the channel whose packet identification information is stored.
